(19) United States
(12) Patent Application Publication
(10) Pub. No.: US 2024/0051459 A1
(43) Pub. Date: Feb. 15, 2024

(54) DIRECTIONAL SIGNAL LIGHT FOR VEHICLES AND SYSTEM

(71) Applicant: Janice Battenfield, Apple Valley, CA (US)

(72) Inventor: Janice Battenfield, Apple Valley, CA (US)

(21) Appl. No.: 17/936,894

(22) Filed: Sep. 30, 2022

Related U.S. Application Data
(60) Provisional application No. 63/396,991, filed on Aug. 11, 2022.

(51) Int. Cl. B60Q 1/34; B60Q 1/26; F21S 43/50; F21S 43/14

(52) U.S. Cl. CPC B60Q 1/34; B60Q 1/2615; B60Q 1/2607; F21S 43/50; F21S 43/14; B60Q 2400/20; B60Q 1/2619; F21W 2103/20

(57) ABSTRACT

The present invention relates to a vehicle directional or U-turn indicating light device and associated system for alerting those nearby about an imminent U-turn to be made by an operator of the vehicle. The U-turn indicating light features an inverted U-shaped illuminating structure having a plurality of LEDs configured to illuminate to indicate a U-turn. The indicating device is mounted on the front portion and rear portion of a vehicle. An actuator system is disposed in a convenient location within the passenger compartment and is used for activating the U-turn light device.

### CROSS-REFERENCE TO RELATED APPLICATION

The present application claims priority to, and the benefit of, U.S. Provisional Application No. 63/396,991, which was filed on Aug. 11, 2022, and is incorporated herein by reference in its entirety.

### FIELD OF THE INVENTION

The present invention relates generally to the field of vehicle turn lights and signal indicators. More specifically, the invention relates to a U-turn or directional indicator light for vehicles for providing drivers with an easy and convenient manner of alerting other drivers, pedestrians, and other roadway users of an imminent U-turn. The indicator light has an inverted U-shape illuminating signal. The signal light is connected to an electric control unit of the vehicle and can be operated by a lever arm or a push button system disposed on dashboard of the vehicle. Accordingly, the present disclosure makes specific reference thereto. Nonetheless, it is to be appreciated that aspects of the present invention are also equally applicable to other like applications, devices, and methods of manufacture.

### BACKGROUND

By way of background, all types of vehicles have integrated conventional right turn signal and left turn signal that are activated using a lever arm mounted generally next to the steering wheel of a vehicle. These signal lights can include integrated turn signal lights on the front and back of the vehicle and sometimes the signal indicators are integrated with the vehicle exterior brake lights. The lever arm or a button system in newer vehicles generally actuates a set of mechanical or electronic switches inside the steering column and/or other types of circuits and/or vehicle computer controls to activate either a right turn signal or a left turn signal for alerting other motorists, motorway users, and pedestrians of an imminent turn.

In operation, a driver operating a vehicle wishing to make a left turn or right turn should give a corresponding turn signal by causing either the front left or right turn lights or rear left and right taillights to start a slow blinking process. However, when a driver wants to make a U-turn signal, a specific U-turn signal is not available and generally, turn signals are provided by the driver or operator which make another driver of a following vehicle or oncoming vehicle assume that the driver is taking a right or left turn. This may result in a crash as the driver taking a U-turn slows down the vehicle more than expected by a trailing driver as a U-turn is generally completed at a lower rate of speed than a conventional right or left turn. Many times, a driver who wants to make a U-turn extends his or her hand outside the vehicle, such as through the window to indicate the desire to make an imminent U-turn. These conventional methods may be ineffective and can lead to miscommunication.

More specifically, a following or trailing driver, can run into the vehicle making the U-turn as they misjudge the forward vehicle's intentions, and wrongfully assume the driver is making a turn but not necessarily a U-turn. In addition, pedestrians crossing the road could be injured by the vehicle making the U-turn as they can incorrectly assume the U-turning vehicle is only making a left or right turn.

Therefore, there exists a long-felt need in the art for a U-turn signal indicator that can help solve the problems associated with indicating an imminent U-turn is about to be made to fellow vehicles and pedestrians. There is also a long-felt need in the art for a vehicle U-turn signal indicator that is convenient and easy to use. Additionally, there is a long-felt need in the art for a vehicle U-turn signal indicating light that informs oncoming and following vehicles that an imminent U-turn is about to be made. Moreover, there is a long-felt need in the art for a vehicle U-turn light signal that can help prevent accidents and crashes with other vehicles and pedestrians while making a U-turn by the vehicle. Further, there is a long-felt need in the art for a vehicle U-turn indicator that can be integrated or retrofitted aftermarket into a vehicle. Finally, there is a long-felt need in the art for a vehicle U-turn signal indicating device and system provided in a vehicle for providing more time for drivers to make their turn and assists in preventing accidents and miscommunication between drivers and pedestrians.

The subject matter disclosed and claimed herein, in one embodiment thereof, comprises a vehicle U-turn signal light indicator. The U-turn signal light indicator is a specialized light for signaling a potential U-turn by a vehicle such as an automobile, and is disposed or located on both the front portion and rear portion of a vehicle for alerting all oncoming and following vehicles and pedestrians about the operator's intention to make an imminent U-turn. The signal light device can be integrated during manufacturing of the vehicle, such as by the OEM, or can be retrofitted to an existing vehicle aftermarket using a magnetic backing to secure the turn signal indicator in position. The U-turn signal light includes a plurality of LEDs arranged to form an inverted U-shape. The inverted U-shape has an arrow end and opposite flat end. The LEDs illuminate in a running or sequential manner in a direction starting from the planar or flat end to the arrow end for indicating a U-turn. The U-turn signal light is manually activated by a driver or operator of the vehicle using an activation means which may include a lever arm or a system of touch or physical buttons for activating and deactivating the U-turn signal. The U-turn signal may be further connected to the existing right and left turn signals and actuator to further signal the direction of the U-turn, either in the left or right direction.

In this manner, the U-turn signal indicator device and associated system of the present invention accomplishes all of the foregoing objectives and provides users with a U-turn signaling indicator for vehicles such as automobiles, that indicates to other drivers, pedestrians, and users of the motorway of an imminent U-turn. The device is disposed or positioned both on the front and rear of the vehicle or automobile and therefore, alerts all oncoming and following vehicles, motorway users, and pedestrians making them fully aware of the imminent U-turn. The device can help in the preventing of accidents, miscommunications, and provides more time to drivers to take a U-turn safely.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a vehicle U-turn or directional signal light indicator. The U-turn signal light is a specialized light for signaling a potential U-turn by a vehicle such as an automobile, and is disposed on both the front portion and rear portion of a vehicle for alerting all oncoming and following vehicles and pedestrians about an imminent U-turn. The U-turn or directional signal light indicator includes a housing having a plurality of LEDs arranged to form an inverted U-shape, or partial U-shape. The U-shape has an arrow at one end and a flat portion on the opposite planar end. The LEDs may illuminate in a select one of numerous different formats including, without limitation, a running, sequential, continuous, incremental or combinations thereof to show a direction starting from the planar end to the arrow end for indicating a U-turn. The U-turn or directional signal light indicator can be integrated into the vehicle or can be retrofitted using a magnetic backing or other suitable fastening to hold the indicator to the vehicle body.

In yet another embodiment, a vehicular U-turn or directional signal light system for indicating an imminent U-turn by a vehicle to other motorists, users of a motorway or thoroughfare, and pedestrians is disclosed. The system includes a first U-turn signal light disposed below the left turn signal light on the front portion of the vehicle and a second U-turn signal light disposed below the left taillight. The system includes a U-turn signal light activation lever arm disposed on the left of the steering of the vehicle or other activation assembly. Upon activation of the switch, the first U-turn signal light and the second U-turn signal light are simultaneously activated for indicating an imminent U-turn on actuation of the lever arm from a neutral position to an activating position. An electronic control unit of the vehicle provides electric power to the first and second light upon actuation of the lever arm.

In yet another embodiment, a vehicular U-turn or directional signal light indicator system for indicating an imminent U-turn by a vehicle to other motorists, other thoroughfare users, and pedestrians is disclosed. The system includes a first U-turn signal light disposed below the left turn signal light on the front portion of the vehicle, a second U-turn signal light disposed below the left taillight, and a U-turn signal light activation system disposed on the dashboard or other convenient location of the vehicle interior. When activated, the first U-turn signal light and the second U-turn signal light are simultaneously activated for indicating an imminent U-turn when a first button of the activation system is pressed by a driver of the vehicle. In an alternate configuration, one of the U-turn signal light indicators is activated and then the other is activated in a continuing sequential manner after the LED lights reach the end of the sequence. An electronic control unit of the vehicle provides electric power to the first and second light when the first button is pressed.

In yet another embodiment, a method for alerting other motorists and pedestrians of an imminent U-turn signal made by a vehicle is described. The method includes the steps of providing a U-turn signal light device integrally or removably attached to the front portion and rear portion of the vehicle, the U-turn signal light device includes LEDs formed in an inverted U-shape configuration, and an activation switch provided in the interior of the vehicle cabin in easy reach of the operator, such as on the dashboard of the vehicle for activating the U-turn signal light device to illuminate the inverted U-shape light for indicating the imminent U-turn.

Numerous benefits and advantages of this invention will become apparent to those skilled in the art to which it pertains upon reading and understanding of the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1A illustrates a front perspective view of an exemplary vehicle equipped with the one potential embodiment of the U-turn signal indicator light of the present invention in accordance with the disclosed description;

FIG. 1B illustrates a rear perspective view of a vehicle equipped with the U-turn signal indicator of the present invention in accordance with the disclosed description;

FIG. 2A illustrates a standalone view of the U-turn signal indicator light of the present invention in accordance with the disclosed specification;

FIG. 2B illustrates a cross sectional view of the side of the light indicator housing of the present invention in accordance with the disclosed specification;

FIG. 3 illustrates a perspective view showing one potential embodiment of the U-turn indicator light activation system of the present invention disposed on the dashboard of a vehicle in accordance with the disclosed description;

FIG. 4 illustrates a perspective view showing a U-turn indicator light activation lever for operating the U-turn lights of the vehicle in accordance with the disclosed specification;

FIG. 5 illustrates a functional block diagram showing an exemplary system of a vehicle for use with the U-turn indicator lights of the present invention in accordance with the disclosed description; and

FIG. 6 illustrates a flow diagram depicting a process of automatic activation of the U-turn indicator lights of the present invention in accordance with the disclosed specification.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long-felt need in the art for a U-turn or directional signal indicator that can solve problems associated with indicating the desire to make a U-turn to fellow vehicles, motorway users, and pedestrians. There is also a long-felt need in the art for a vehicle U-turn indicator that is convenient and easy to use. Additionally, there is a long-felt need in the art for a vehicle U-turn indicating light indicator device that informs oncoming and following vehicles about the desire to make a U-turn. Moreover, there is a long-felt need in the art for a vehicle U-turn light indicator device that can help prevent accidents and crashes with other vehicles and pedestrians while making a U-turn by a vehicle. Further, there is a long-felt need in the art for a vehicle U-turn indicator that can be integrated as part of an original OEM package or retrofit in a vehicle in an aftermarket situation. Finally, there is a long-felt need in the art for a vehicle U-turn signal indicating device and system for use with a vehicle for providing more time for drivers to make their turn and assist in preventing accidents and miscommunication between drivers, pedestrians, and others that may need to be aware that a vehicle operator is making a U-turn.

The present invention, in one exemplary embodiment, is a vehicular U-turn signal light system for indicating an imminent U-turn by a vehicle to other motorists and pedestrians. The system includes a first U-turn signal light disposed on a portion of the front of the vehicle body such as below the left-hand turn signal light area, and a second U-turn signal light disposed on the back or rear portion of the body such as below the left taillight. A U-turn signal light activation switch disposed at an easily reachable area within the passenger cabin of a vehicle, such as on left of the steering column of the vehicle. The first U-turn signal light and the second U-turn signal light are one of simultaneously, sequentially, or incrementally activated for indicating an imminent U-turn upon actuation of the activation switch from a neutral position to an activating position. An electronic control unit of the vehicle provides electric power to the first and second light upon actuation of the lever arm.

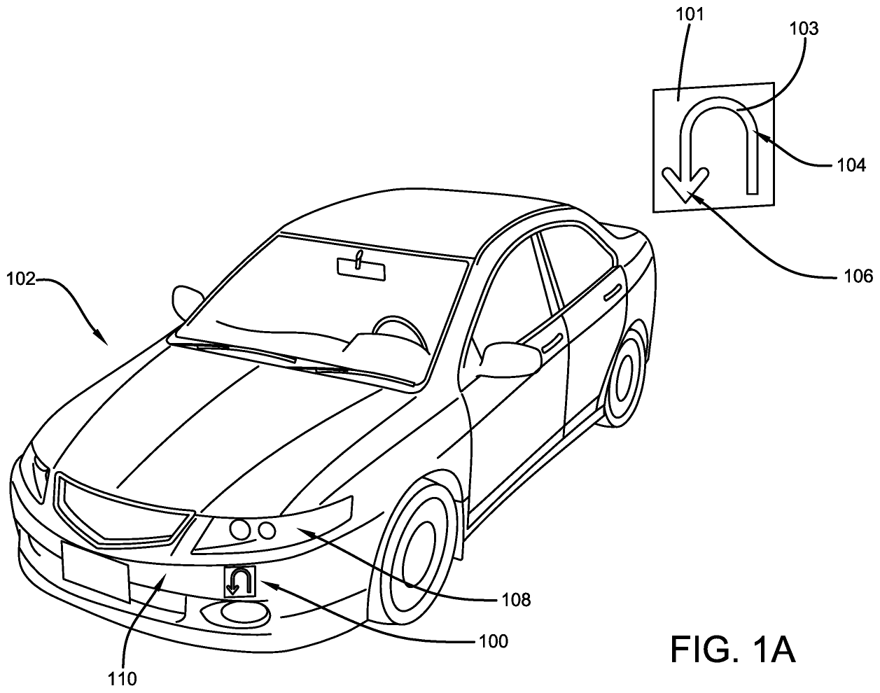

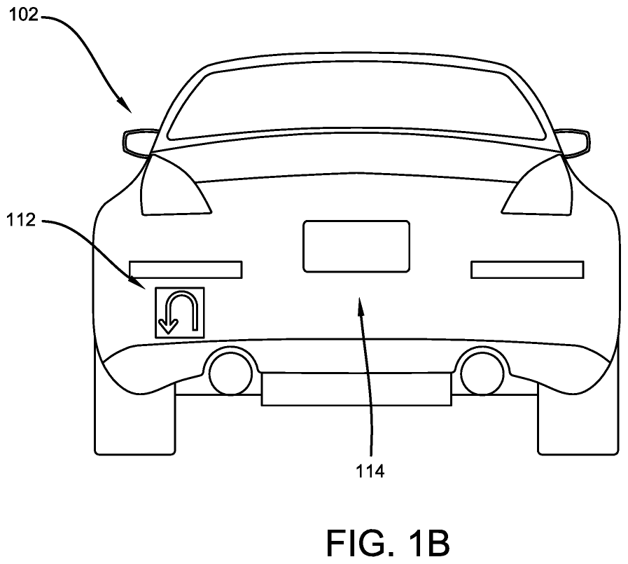

Referring initially to the drawings, FIG. 1A illustrates a front perspective view of an exemplary vehicle equipped with one potential embodiment of the U-turn signal indicator light 100 of the present invention in accordance with the disclosed specification. The U-turn signal indicator light 100 is designed to indicate and alert other vehicle operators and pedestrians about an imminent U-turn by a driver of the vehicle 102. The U-turn signal indicator light 100 eliminates the need for verbal communication, hand signals, or any confusion between drivers when one driver is making a U-turn. More specifically, the U-turn signal indicator light 100 is comprised of a weatherproof housing 101 with a signal light 103 having a generally inverted U-shape light 104. The U-shape light 104 has a first end with an arrow shape 106 for indicating the direction of an imminent U-turn by the driver of the vehicle 102. The signal light 100 in the present embodiment, is preferably positioned on the front bumper and preferably below the front left turn signal light 108 positioned on the front portion 110 of the vehicle 102 for alerting oncoming vehicles and pedestrians of the potential U-turn.

The U-turn light 100 is integrally attached or mounted to the vehicle 102 during manufacturing of the vehicle 102. Alternatively, the light 100 can be retrofitted to the vehicle 102 as an aftermarket device. When retrofitted on the vehicle 102, the U-turn light 100 uses a magnetic backing or adhesive 117,119 allowing the light 100 to be secured to the surface of the front portion 110. If the portion to which the light 100 is to be secured is fiberglass, composite, or other material to which a magnet may not attach, then an adhesive is used. The adhesive may be a permanent, removable, or repositionable adhesive. If a permanent adhesive is used, preferably it is an acrylic adhesive. A removeable or repositionable adhesive allows the light 100 to be positioned on different portions of the vehicle 102. The light 100 is positioned in the front portion 110 and can be of different sizes as per design of the vehicle 102.

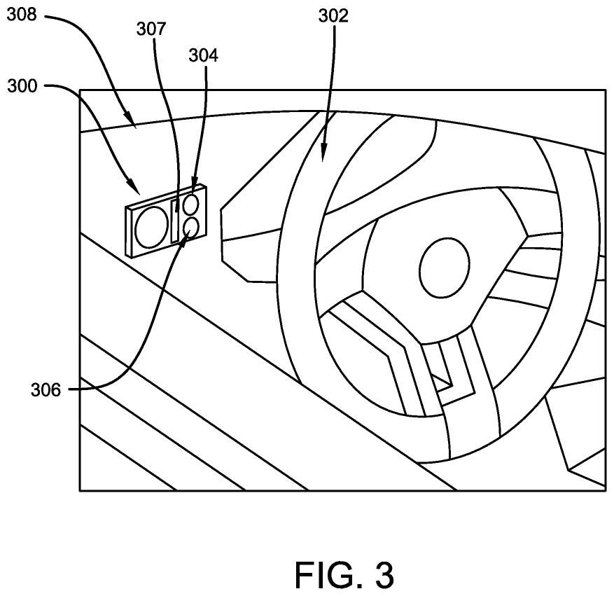

FIG. 1B illustrates a rear perspective view of the vehicle 102 equipped with the U-turn or directional signal indicator 100 of the present invention in accordance with the disclosed specification. The U-turn signal indicator light 100 is located below the left taillight 112 on the rear portion 114 for allowing the following vehicles and pedestrians to be fully aware about the imminent U-turn by driver of the vehicle 102. The U-turn light 100 positioned on both the front portion 110 and the rear portion 114 are illuminated in one of a simultaneous, sequential, or incremental operation as described in FIGS. 3 & 4 for alerting those nearby and particularly the oncoming and following vehicles about an intention to make a U-turn. The indicator light 100 positioned at the rear portion 114 can also be integrated in the vehicle 102 or alternatively, can be retrofitted to the vehicle 102 using a magnetic or adhesive backing.

It should be noted that the U-turn indicator light 100 can be designed for both left hand drive vehicles 102 and right hand drive vehicles 100 allowing a driver to alert other vehicles and pedestrians.

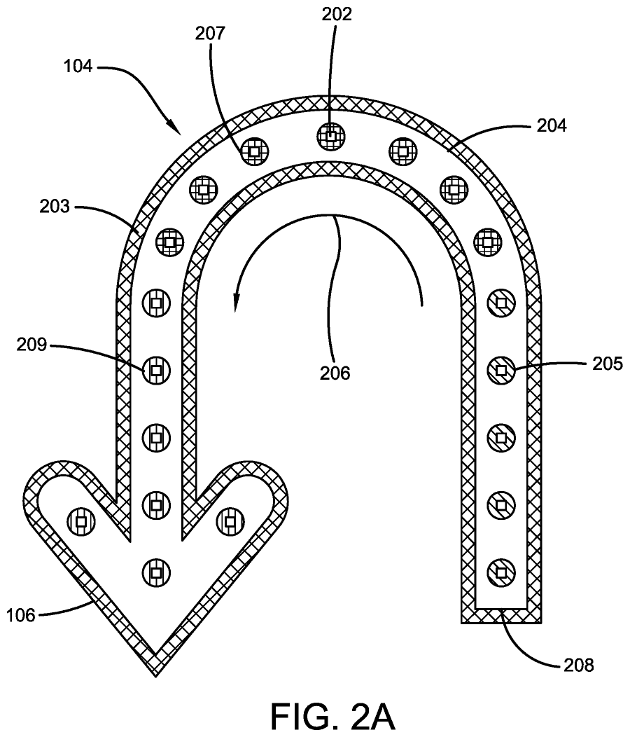

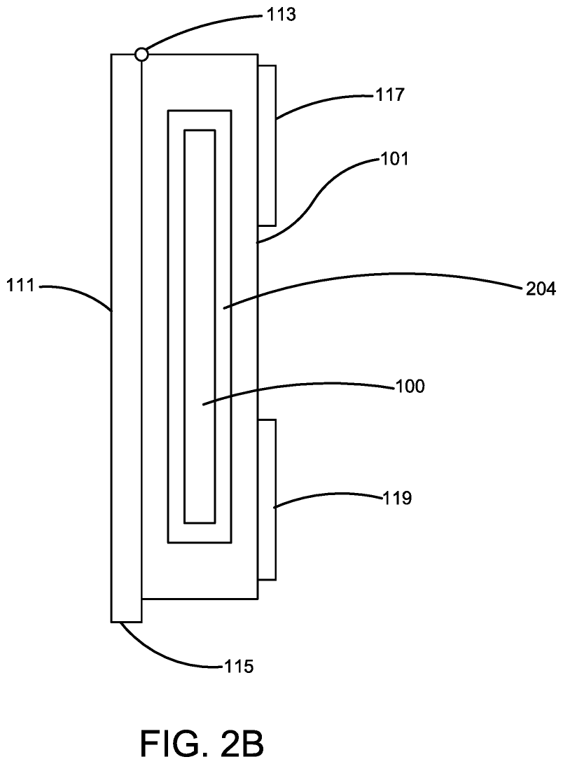

FIG. 2A illustrates a standalone view of the U-turn or directional signal indicator light 100 of the present invention in accordance with the disclosed specification. The U-shaped light 104 includes a plurality of light emitting diodes (LEDs) 202 or other light source disposed in the weatherproof light housing or casing 204 to provide illumination and blinking. The LEDs 202 are preferably uniformly distributed across the U-shaped light 104 and are preferably arranged and activated in one embodiment, such that the LEDs 202 blink in a manner that appears like each LED 202 is chasing a consecutive LED 202 in one direction (i.e., toward the arrow end 106). Accordingly, the LEDs 202 may blink in a running manner in the direction 206 starting from the first end 208 toward the arrow end 106 to indicate an imminent U-turn. The LEDs 202 may also be activated so that all the LEDs 202 are activated at one time or in separate groups 205, 207 and 209. In addition, the lighting groups 205, 207 and 209 may be in different colors, such as but not limited to green, yellow, and red providing a further indication of the stage of the turn and presenting different warning light indicators at each stage. The light housing or casing 204 may also be surrounded by a retroreflective material 203, such as, but not limited to, a beaded material or prismatic material or a combination of to increase the visibility of the light 100.

When operated in the running configuration, the blinking of the LEDs 202 provide the ability to an operator of a vehicle 102 to indicate the intended U-turn movement toward the left of the vehicle on which the indicator light 100 is mounted. The indicator 100 is configured to be mounted to the front and rear of the vehicle 102 as shown in FIGS. 1A & 1B during the manufacturing of the vehicle 102 or can be retrofitted to an existing vehicle 102.

It should be understood that although the preferred embodiment has blinking of LEDs 202 providing a running appearance, the LEDs 202 may also blink without providing a running appearance, such as, but not limited to, in a simultaneous and incremental configuration. Further, it should be understood that the indicator 100 of the present invention is used to inform motorists and pedestrians of a user's intent to make a U-turn with many types of vehicles and should not be limited to any particular type of vehicle described herein.

FIG. 2B provides a cross-sectional view of the lighting system 100 which is contained within the light casing 204 and is held by the exterior housing 101. The exterior housing 101 may be opaque, transparent, or translucent. The housing 101 has a lid or cover 111 which is openable by a hinge 113 so that the lighting system 100 can be changed or serviced as needed. The lid or cover 111 is preferably made from a transparent material so that the light signal 103 is visible through the cover. The cover 111 also includes a lip or tab 115 to facilitate opening the cover to gain access to the interior of the cover. Attached to the exterior housing 101 are attachment elements 117 and 119 which may be magnetic or adhesive to allow the housing 101 to be connected to a vehicle 102 depending on the material used on the body portion to which the housing is attached. The magnetic material is preferably a neodymium iron boron (NdFeB), samarium cobalt (SmCo), alnico, and ceramic or ferrite magnet. The adhesive may be permanent, removable, or repositionable depending on the user application that is necessary. If an adhesive is used, it may be covered with a release liner which when removed, will reveal an active or tacky adhesive. While the exterior housing is illustrated as square or rectangular, it should be understood that any suitable shape, circular, triangular or fanciful may be used in order to meet the preferences of the vehicle owner or body type.

FIG. 3 illustrates a perspective view showing one potential embodiment of the U-turn indicator light activation system 100 disposed in the passenger cabin of a vehicle 102, such as on the dashboard 308 of a vehicle 102 in accordance with the disclosed specification and drawings. In this embodiment, the U-turn indicator light activation system 300 is preferably positioned at a convenient and easy to reach place for the operator of the vehicle 102, such as on the dashboard 308 on the left side of the steering wheel 302 of a vehicle. The system 100 is designed to selectively operate the U-turn signal light positioned on the front 110 and rear portion 114 of the vehicle 102. The system 300 can be deployed during manufacturing of the vehicle 102 or alternatively can be retrofitted using a magnetic or adhesive backing.

A first button 304 is configured to activate the light 100 positioned on the front 110 and rear 114 of the vehicle 102 for alerting others about an imminent U-turn. A second button 306 is configured to deactivate the light 100 positioned on the front and rear of the vehicle simultaneously. An additional switch 307 is provided so that the operator can select the configuration of the light activation from simultaneous, to sequential, to incremental, as well as the lighting configuration to running, continuous, segmented.

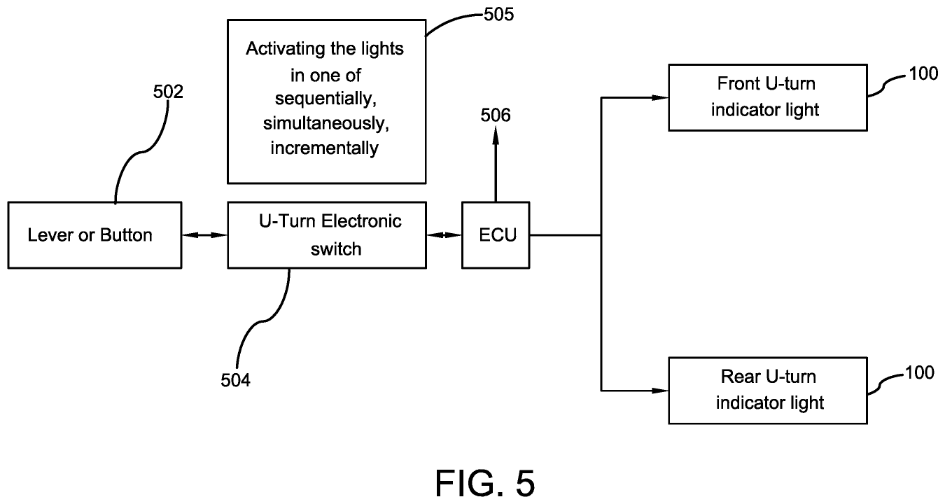

In the preferred embodiment, the U-turn indicator light activation system 300 is connected to the light 100 via a wired switch system as illustrated in FIG. 5. Alternatively, in a retrofitted system, the system 300 may be wirelessly coupled to the individual U-turn lights 104 positioned on the front 110 and rear 114 of the vehicle 102.

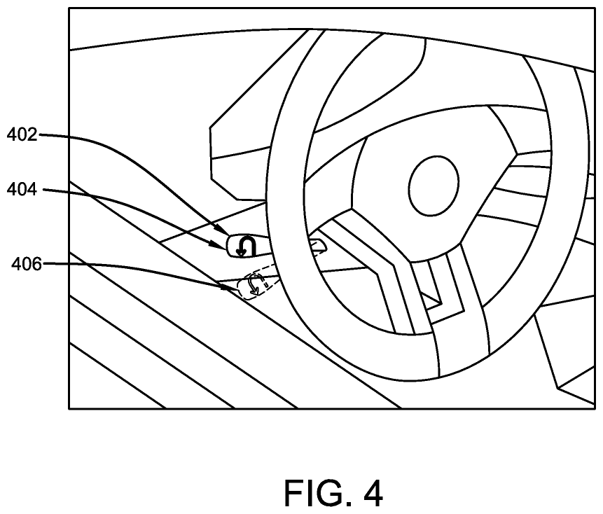

FIG. 4 illustrates a perspective view showing a U-turn indicator light activation lever 402 for operating the U-turn lights 104 of the vehicle 102 in accordance with the disclosed specification and drawings. The lever 402 is configured to operate and specifically, turn on and off the U-turn lights 104. The U-turn indicator lights 100 are deactivated when the lever 402 is positioned in a neutral position 404. In use, the U-turn signal lever 402 is actuated to an activation position 406 to activate the U-turn indicator lights 104. The activation position 406 may be through pushing the lever forward, backward, or inward so as not to trigger the usual left or right turn signal by lifting the lever up or pushing the lever down.

FIG. 5 illustrates a functional block diagram showing an exemplary system of a vehicle 102 for working of the U-turn indicator lights of the present invention in accordance with the disclosed specification and drawings. The lights 100 can be activated by a system 300, a lever arm 402, or switch 307 as described in FIGS. 3 & 4. The configured system and lever arm (referred here as 502) are connected to a U-turn electronic switch 504 which in turn, is connected to a vehicle's electric control unit (ECU) 506. The electronic switch 504 can be used to switch the U-Turn signal 104 to different modes of operation such as simultaneously, sequentially, or incrementally in block 505. It should be noted that the U-turn electronic switch 504 can be integrated in the vehicle 102 during manufacturing of the vehicle 102 or can be retrofitted to electrically connect to the ECU 506. The ECU 506 connects to the U-turn light 104 through a hard-wired connection or in an aftermarket configuration, wirelessly, such as through the vehicle's Wi-Fi system thereby providing the internal electric power of the vehicle to the U-turn indicator lights.

The U-turn electronic switch 504 closes the connection with the ECU 506 when the U-turn indicator lights are activated. Similarly, the connection between the switch 504 and the ECU 506 is open when the lights are deactivated.

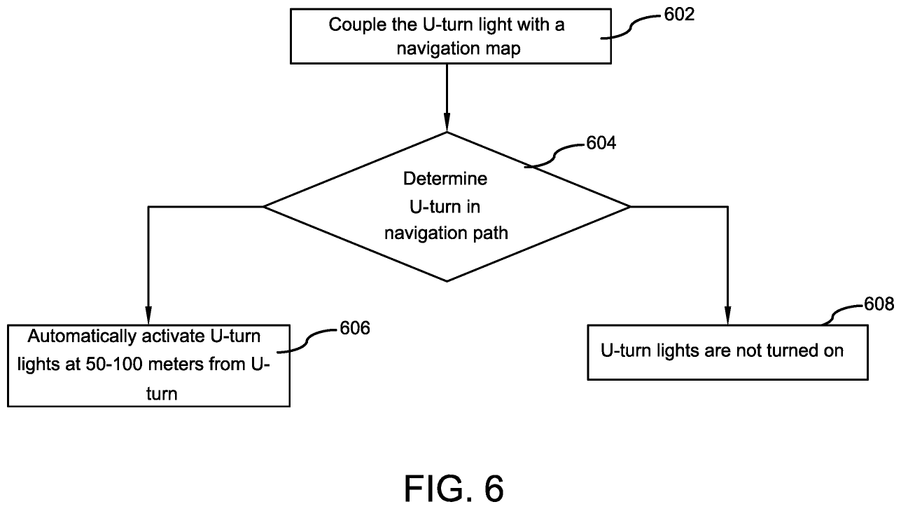

FIG. 6 illustrates a flow diagram depicting a process of automatic activation of the U-turn indicator lights 100 of the present invention in accordance with the disclosed specification and drawings. The U-turn indicator lights 104 can also be automatically activated in accordance with some of the embodiments of the present invention. In the present embodiment, for automatic activation of the U-turn signals, the U-turn lights 104 are coupled with a navigation map, such that the navigation map is displayed by the dashboard of the vehicle (Step 602). Based on the navigation path of the map, for example when the directions input into the navigator system require a U-turn to arrive at the destination or a U-turn is required due to the operator of the vehicle taking a wrong turn and the navigation system is making a correction, an upcoming U-turn is detected (Step 604). In case, a U-turn is detected, the U-turn lights are automatically activated at least 50 to 100 meters before the U-turn (Step 606). If no U-turn is detected, then the U-turn lights are not activated automatically (Step 608).

The U-turn lights of the present invention can also be configured to work in conjunction with the integrated front camera of a vehicle wherein when a U-turn is detected by the camera, then the U-turn lights are automatically activated.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “U-turn or directional signal light”, “U-turn indicator light”, “indicator light”, and “U-turn or directional light” are interchangeable and refer to the vehicular U-turn signaling device 100 of the present invention.

Notwithstanding the foregoing, the vehicular U-turn signaling device 100 of the present invention can be of any suitable size and configuration as is known in the art without affecting the overall concept of the invention, provided that it accomplishes the above-stated objectives. One of ordinary skill in the art will appreciate that the vehicular U-turn signaling device 100 as shown in the FIGS. are for illustrative purposes only, and that many other sizes and shapes of the vehicular U-turn signaling device 100 are well within the scope of the present disclosure. Although the dimensions of the vehicular U-turn signaling device 100 are important design parameters for user convenience, the vehicular U-turn signaling device 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

1. A directional indicator signal comprising:
a housing comprising a transparent cover hingedly attached to the housing; and
a signal light comprised of an arrow shaped end, a flat or planar end positioned opposite the arrow shaped end, wherein the signal light is contained within the housing; and
wherein the transparent cover comprises a tab configured to facilitate opening the transparent cover to access the signal light.

2. The directional indicator signal as recited in claim 1, wherein the signal light is a U-shaped signal light.

3. The directional indicator signal as recited in claim 1, wherein the light is an LED light.

4. The directional indicator signal as recited in claim 1, wherein the light is operational in a a simultaneous mode, a sequential mode or an incremental mode.

5. The directional indicator signal as recited in claim 1, wherein the housing further comprises a retroreflective element.

6. The directional indicator signal as recited in claim 5, wherein the retroreflective element is comprised of a beaded material or a prismatic material.

7. The directional indicator signal as recited in claim 1, wherein the housing further comprises a magnet and an adhesive attachment element.

8. The directional indicator signal as recited in claim 7, wherein the magnetic element is comprised of a neodymium iron boron (NdFeB), a samarium cobalt (SmCo), an alnico, a ceramic or a ferrite magnet.

9. The directional indicator signal as recited in claim 7, wherein the adhesive attachment element is comprised of a permanent adhesive, a removable adhesive or a repositionable adhesive.

10. (canceled)

11. A U-turn signal indicator comprising:
a signal housing having a transparent cover openable via a hinge;
a signal light comprising a plurality of LED lights operated in one of a sequential mode, a simultaneous mode or an incremental mode to signal a U-turn, wherein the signal light is positioned within the signal housing; and
an attachment element; and
wherein the plurality of LED lights are configured to change color to indicate a stage of a U-turn.

12. The U-turn signal indicator as recited in claim 11, wherein the signal housing is further comprised of a retroreflective element.

13. (canceled)

14. (canceled)

15. (canceled)

16. (canceled)

17. A system for signaling a U-turn comprising:
a U-turn signal indicator comprised of an LED light
comprising an arrow shaped end and a flat end opposite the arrow shaped end;
a housing comprising a transparent hinged cover comprising a tab to facilitate opening the transparent hinged cover to access the LED light retained within the housing,
an actuator attachable to a dashboard of a vehicle, wherein the actuator comprises a light activating button, a light deactivating button, and a light mode button; and
an electronic control unit in electrical communication with each of the U-turn signal indicator and the actuator; and
wherein the actuator is in wireless communication with the U-turn signal indicator.

18. The system for signaling a U-turn as recited in claim 17, wherein the housing further comprises a retroreflective element.

19. The system for signaling a U-turn as recited in claim 17, wherein the housing further comprises a magnetic attachment element or an adhesive attachment element.

20. The system for signaling a U-turn as recited in claim 17, wherein the system further comprises a second U-turn signal indicator.
